(19) United States
(12) Patent Application Publication
(10) Pub. No.: US 2014/0198056 A1
(43) Pub. Date: Jul. 17, 2014

(54) DIGITAL IMAGE PROCESSING METHOD AND COMPUTING DEVICE THEREOF

(71) Applicant: NOMOVOK CO., LTD., Taipei (TW)

(72) Inventor: Aki Kalevi Kolehmainmen, Tiapei (TW)

(73) Assignee: Nomovok Co. Ltd., Taipei (TW)

(21) Appl. No.: 13/742,266

(22) Filed: Jan. 15, 2013

(51) Int. Cl. G09G 5/00; G06F 3/041

(52) U.S. Cl. CPC G09G 5/00; G06F 3/041
USPC 345/173

(57) ABSTRACT

A computing device-implemented method and the computing device thereof are provided. A center area and an outer area of the picture displayed on the touch-sensitive screen are defined. An image processing operation, such as zooming in, zooming out, or movement on the picture displayed on the touch-sensitive screen is performed based on the relationship of the initial location and the orientation of the sliding motion, and the center area and the outer area of the picture. Therefore, basic picture operations can be carried out by a single finger possibly while holding the device with the same palm to improve usability and to user safety.

### BACKGROUND OF THE INVENTION

1. Field of the Invention

The present invention relates in general to a touch-based zooming technology in an electronic device and, more particularly, to an electronic device having a touch-sensitive screen, and a touch-based zooming control method in such a device.

2. Related Art

It is in known art that the electronic devices, particular hand-held devices, to may employ touch panels. With this type of information processing device, more intuitive operations are realized by using touch operations, such as tapping, dragging, sweeping etc., on the touch panel. For example, the sweeping is an operation in which a surface of the touch panel is lightly flicked by a finger.

Recently, touch-screen displays have become popular user interfaces for is certain electronic devices. Touch-screens are especially conducive to small electronic devices at least because they allow for an expansive set of user inputs and can replace other limited input interfaces such as dedicated mechanical input buttons. However, there remains room to improve upon standard touch screen interfaces.

For example, the zooming function of the mobile device is used by means of two finger interactions. Therefore, the user has to use both palms when using the zooming function. Unfortunately, this may cause inconvenience to a user who frequently uses a zooming function of the mobile device. Also, due to the zooming function is based on a multi-touch input by means of two finger interactions. Therefore, this technique may not be applicable to a mobile device having a normal touch screen incapable of handling a multi-touch input.

### SUMMARY OF THE INVENTION

To solve the aforementioned problems of the prior art, the present invention provides a digital image processing method and the computing device thereof that allow improved operability when performing an image processing operation, particular in zooming processing.

Accordingly, the present invention discloses a computing device-implemented method. The method comprising: detecting, by a processor of the computing device, that a sliding motion is being made on a touch screen of the computing device; detecting, by the processor and in response to detecting the sliding motion, an initial location and an initial orientation of the sliding motion; identifying, by the processor and in response to detecting the sliding motion and the initial location and the initial orientation of the sliding motion, an item, being displayed by the touch screen, wherein a center area and an outer area of the item are defined; and zooming in or zooming out, by the processor, on the item displayed on the touch screen based on the relationship of the initial location and the initial orientation of the sliding motion, and the center area and the outer area of the item and in response to the processor detecting that the sliding motion is being made on the touch screen.

In another embodiment, the present invention provides a computing device comprising: a touch-sensitive screen; a memory to store a plurality of instructions; and a processor to execute instructions in the memory to: detect a sliding motion is being made on the touch-sensitive screen; detect, in response to detecting the sliding motion, an initial location and an initial orientation of the sliding motion; identify, in response to detecting the sliding motion and the initial location and the initial orientation of the sliding motion, an item, being displayed by the touch screen, wherein a center area and an outer area of the item are defined; and zoom in or zoom out on the item displayed on the touch-sensitive, in response to the processor detecting that the sliding motion is being made on the touch-sensitive screen, based on the relationship of the initial location and the orientation of the sliding motion, and the center area and the outer area of the item.

These and other features, aspects, and advantages of the present invention will become better understood with reference to the following description and appended claims. It is to be understood that both the foregoing general description and the following detailed description are examples, and are intended to provide further explanation of the invention as claimed.

### BRIEF DESCRIPTION OF THE DRAWINGS

The present invention will become more fully understood from the detailed description given herein for illustration only, and thus is not limited to the present invention, and wherein:

FIGS. 1, 2 and 3 are respective views of exemplary embodiments of the computing device in accordance with the present invention;

FIG. 4 is block diagram of the computing device in accordance with the present invention;

FIGS. 5A to 5B are respective views of the area definition of the picture in embodiments in accordance with the present invention;

FIGS. 6A to 6B illustrate examples of the image processing of the computing device-implemented method in accordance with the present invention, showing an exemplary process of zooming out the picture;

FIGS. 7A to 7B illustrate examples of the image processing of the computing device-implemented method in accordance with the present invention, showing an exemplary process of zooming in the picture;

FIGS. 8A to 8B illustrate examples of the image processing of the computing device-implemented method in accordance with the present invention, showing an exemplary process of moving the picture;

FIGS. 9A to 9D illustrate examples of the image processing of the computing device-implemented method in accordance with the present invention, showing an exemplary process of zooming out and in the picture;

FIGS. 10A to 10B illustrate examples of the image processing of the computing device-implemented method in accordance with the present invention, showing an exemplary process of zooming in the picture;

FIGS. 11A to 11B illustrate examples of the image processing of the to computing device-implemented method in accordance with the present invention, showing an exemplary process of showing the control;

FIGS. 12A to 12B illustrate examples of the image processing of the computing device-implemented method in accordance with the present invention, showing an exemplary process of hiding the control;

FIGS. 13A to 13B illustrate examples of the image processing of the computing device-implemented method in accordance with the present invention, showing an exemplary process of changing the picture; and

FIGS. 14A to 14B illustrate examples of the image processing of the computing device-implemented method in accordance with the present invention, showing an exemplary process of changing the picture.

### DETAILED DESCRIPTION OF THE INVENTION

Reference will now be made in detail to the present preferred embodiments of the invention, examples of which are illustrated in the accompanying drawings. Wherever possible, the same reference numbers are used in the drawings and the description refers to the same or the like parts.

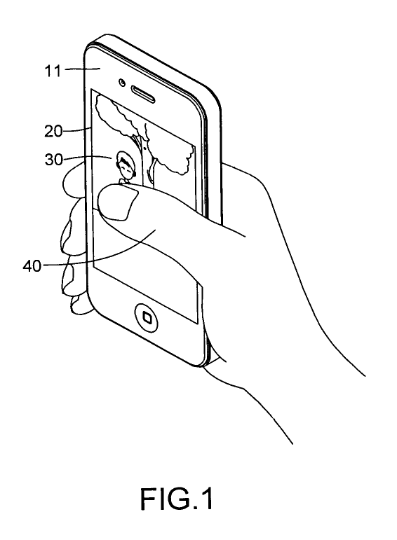

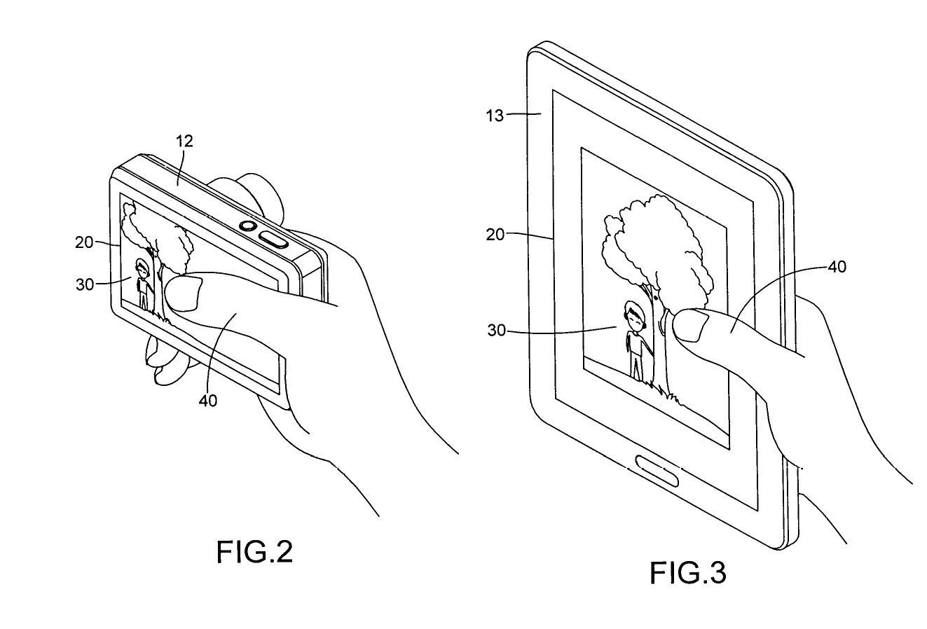

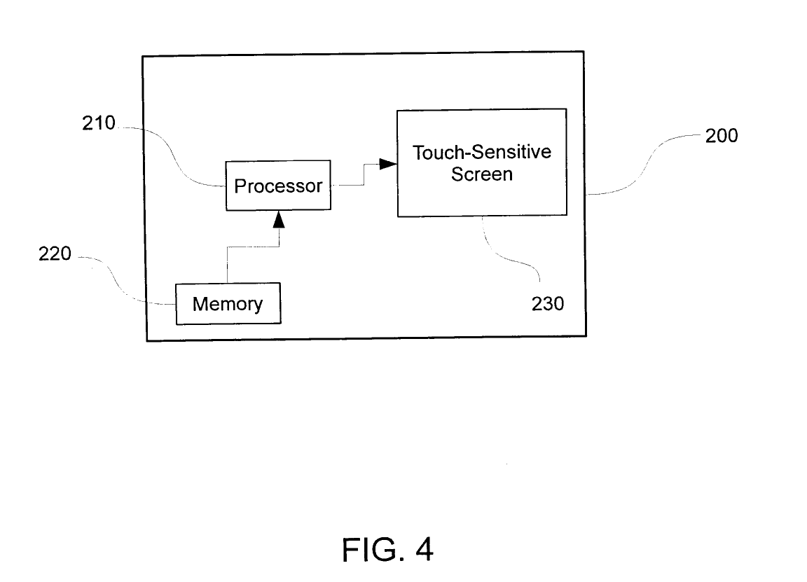

Devices and/or methods described herein may provide a user interface for processing the digital images. The device may include, for example, a smart phone, a personal digital assistant (PDA), a tablet personal computer, a laptop computer, a remote control (e.g., for a television), a digital camera, a portable gaming system, a display device, a global positioning system (GPS) device, etc. FIGS. 1, 2 and 3 provide diagrams illustrating an exemplary implementation of the device, such as the smart phone 11, see FIG. 1, the digital camera 12, see FIG. 2, and the tablet personal computer 13, see FIG. 3. As illustrated, the device, the smart phone 11, the digital camera 12, or the tablet personal computer 13, may include a touch-sensitive screen (also called a touch screen) 20 to show an item, such as a picture 30 thereon. As is known in the art, a touch screen is a type of display that can detect the presence and location of touch within the display area.

As illustrated in FIG. 1, assume that a picture 30 is being displayed via touch screen 20. According to implementations described herein, the picture 30 may be processed by a user using a single finger, especially by the thumb 40 so that the user can operate by one palm. For example, a zoom in operation (e.g., to enlarge a displayed portion of picture 30), a zoom out operation (e.g., to shrink a displayed portion of picture 30), or a movement may be performed on picture 30.

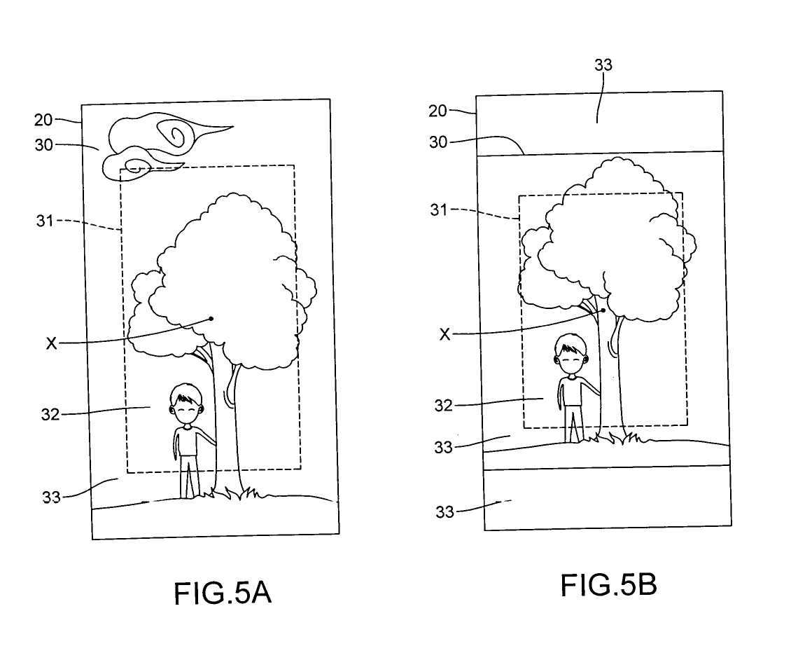

FIG. 4 is an exemplary block-diagram of the device. As illustrated, the device 200 may include a processor 210, a memory 220, and a touch-sensitive screen 230. The processor 210 may include one or more microprocessors, application specific integrated circuits (ASICs), field programmable gate arrays (FPGAs), or the like. The processor 210 controls the operations of device 200 and its components. In one implementation, the processor 210 may control operation of components of device 200 in a manner described herein.

The memory 220 may be a random access memory (RAM), a read-only memory (ROM), or another type of memory to store data and instructions that may be used by the processor 210. In one implementation, memory 220 may store instructions for performing a zooming operation on one or more items displayed on the screen 230. The touch-sensitive screen 230 is configured to receive a user input, especially a sliding motion. The processor 210 is configured to perform the instructions in response to the user input.

As will be described in detail below, the device 200 may perform certain operations described herein in response to the processor 210 executing software instructions of an application contained in a computer-readable medium, such as the memory 220. A computer-readable medium may be defined as a physical or logical memory device. A logical memory device may include a space within a to single physical memory device or spread across multiple physical memory devices. The software instructions may be read into the memory 220 from another computer-readable medium. The software instructions contained in the memory 220 may cause the processor 210 to perform processes that will be described later.

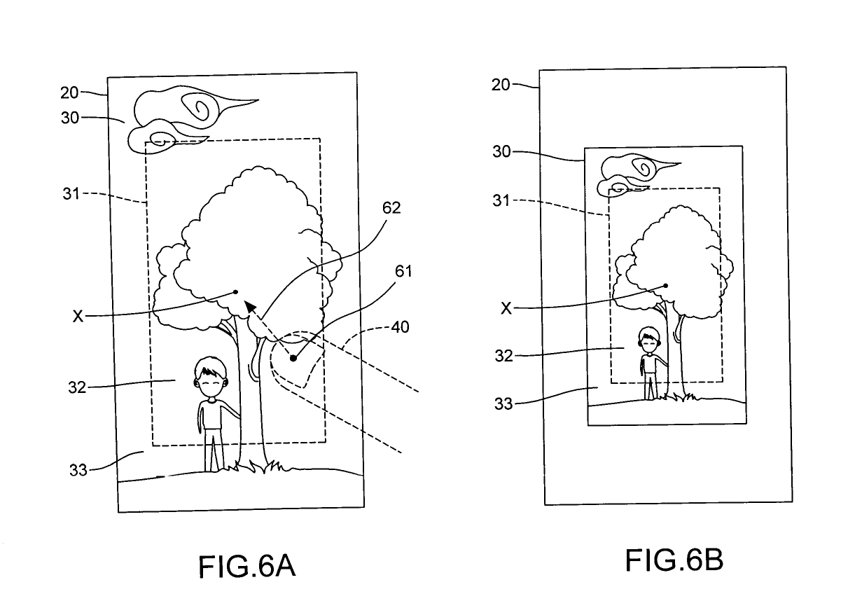

The picture 30 is processed based on the initial location and the initial orientation of the sliding motion. Therefore, please see FIG. 5A, a center area 32 and an outer area 33 of the picture 30 are defined. The outer area 33 is 15% of a width and a height of the picture 30 counting from edges of all sides of the picture 30. And the center area 32 covers the remaining area of the picture 30, totaling 70% of the width and height of the picture. A boundary 31 is presented therebetween. Therefore, the shape and the absolute size of the center area 32 vary depending on the shape and the size of the picture 30. When the aspect ratio of the picture 30 differs from the aspect ratio of the screen 20, the empty or blank areas are regarded as parts of the outer area 33, please refer to FIG. 5B. When the user first touches the picture 30, the boundary 31 or the center area 32, the outer area 33 is indicated by flashing, coloration, sound etc.

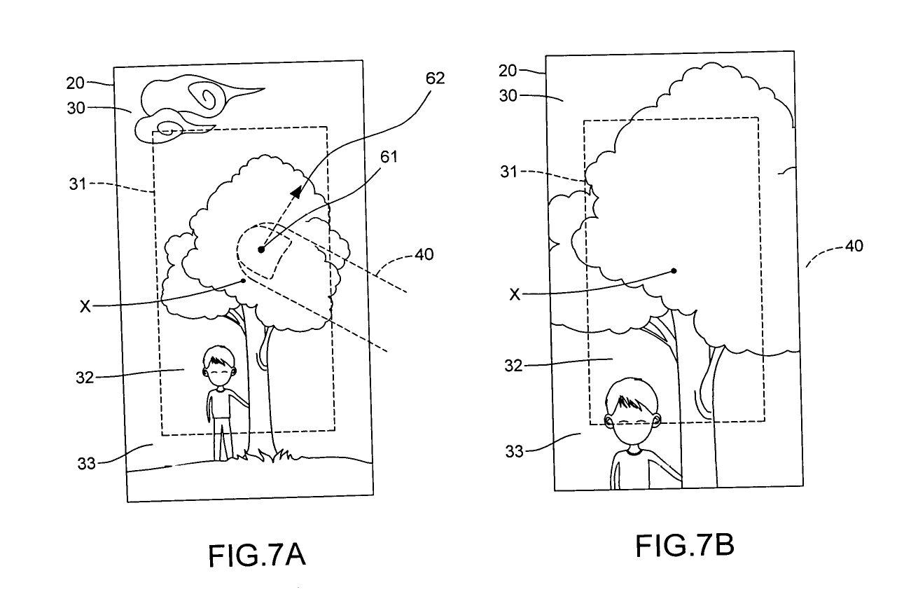

Please refer to FIGS. 6A and 6B, when the initial location 61 is located at the center area 32 and the initial orientation 62 of the sliding motion is towards to a focal point X of the picture 30, the zooming out from the same initial location is performed by the processor 210 as long as the sliding motion continues regardless of a later direction of the same sliding motion.

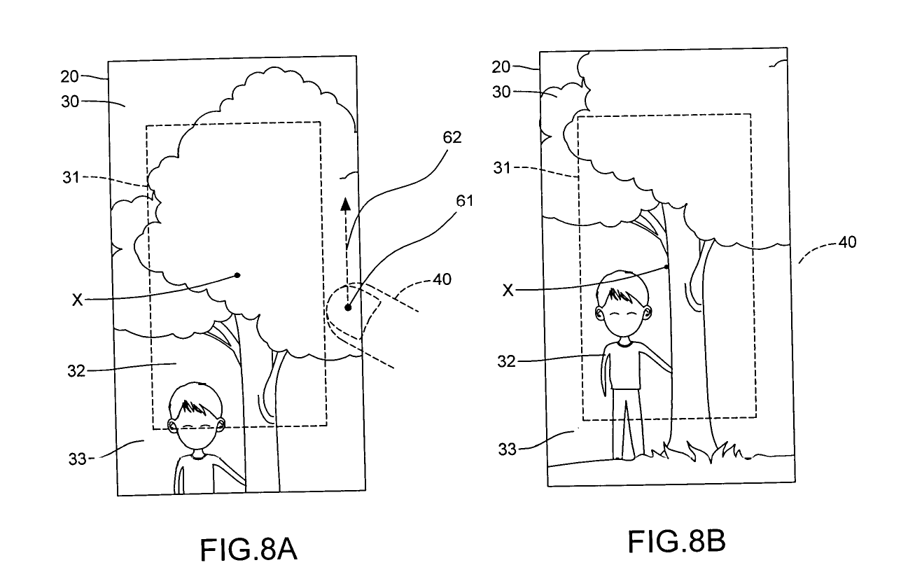

Please refer to FIGS. 7A and 7B, when the initial location 61 is located at the center area 32 and the initial orientation 62 of the sliding motion is outwards from the focal point X of the picture 30, the zooming in to the same initial location is performed by the processor 210 as long as the sliding motion continues regardless of a later direction of the same sliding motion.

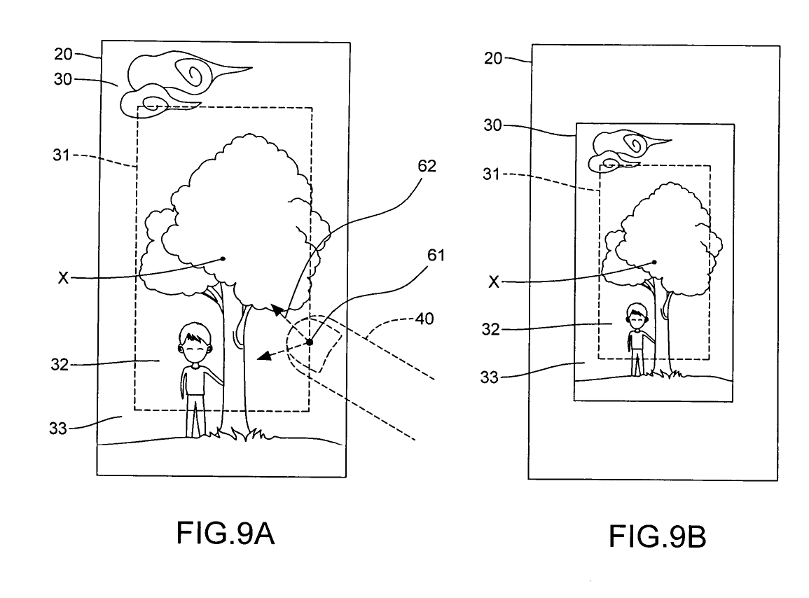

Please refer to FIGS. 8A and 8B, when the picture 30 is zoomed in, and the initial location 61 is located at the outer area 33, the picture 30 is moved by the processor 210 along the orientation 62 of the sliding motion.

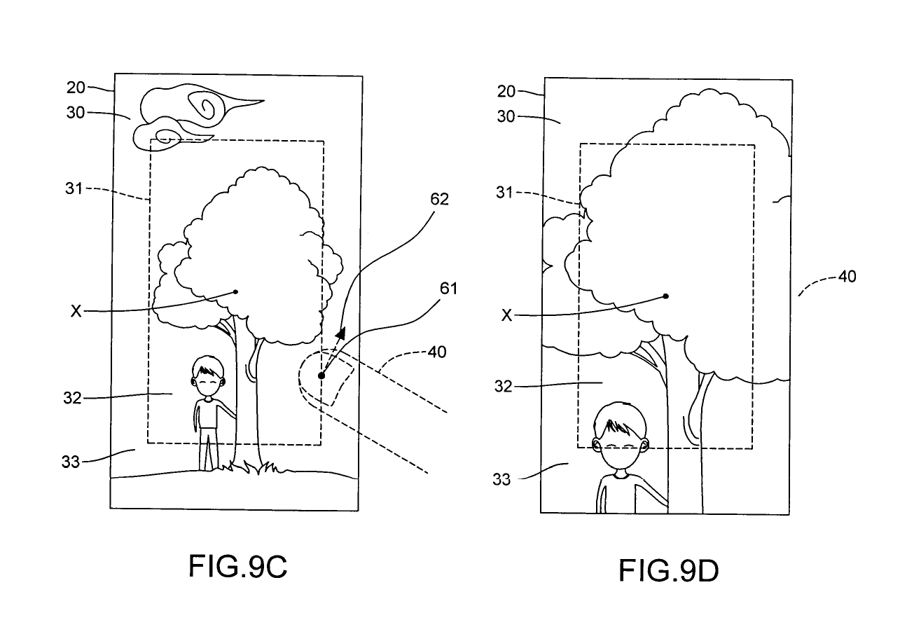

Please refer to FIGS. 9A to 9D, when the initial location 61 is located at the boundary 31 of the center area 32, the zooming out from or in to the same initial location 61 is performed by the processor 210 depending on the initial orientation 62 of the sliding motion. On the other hand, when the initial orientation 62 of the sliding motion is towards to a focal point X of the picture 30, the zooming out is performed by the processor 210, please see FIGS. 9A and 9B. When the initial orientation 62 of the sliding motion is outwards from the focal point X of the picture 30, the zooming in is performed by the processor 210, please see FIGS. 9C and 9D.

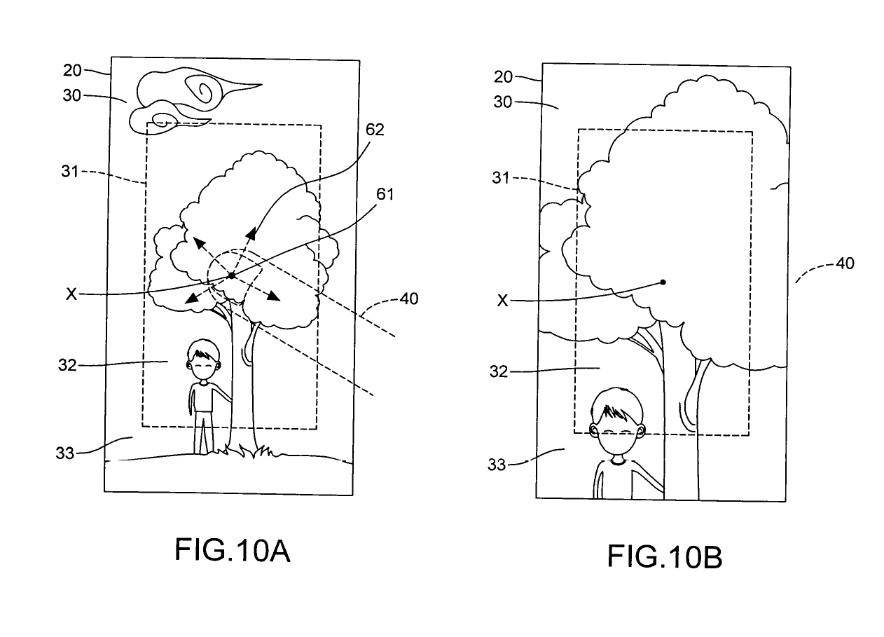

Please refer to FIGS. 10A and 10B, when the initial location 61 is located at the focal point X of the picture 30, the zooming in to the same initial location 61 is performed by the processor 210. Also, the memory 220 further includes a plurality of parameters. The parameters are associated with how the zooming in or zooming out is performed by the processor 210. The parameters include a minimum or a maximum size parameter that indicates a percentage of an original size to which the picture 30 can be zoomed out or zoomed in. The original size corresponds to a displayed size of the picture 30 prior to the sliding motion. The zooming out on the picture 30 is performed to a size corresponding or exceeding the minimize size parameter. And the zooming in on the picture 30 is performed to a size at or below the maximum size parameter.

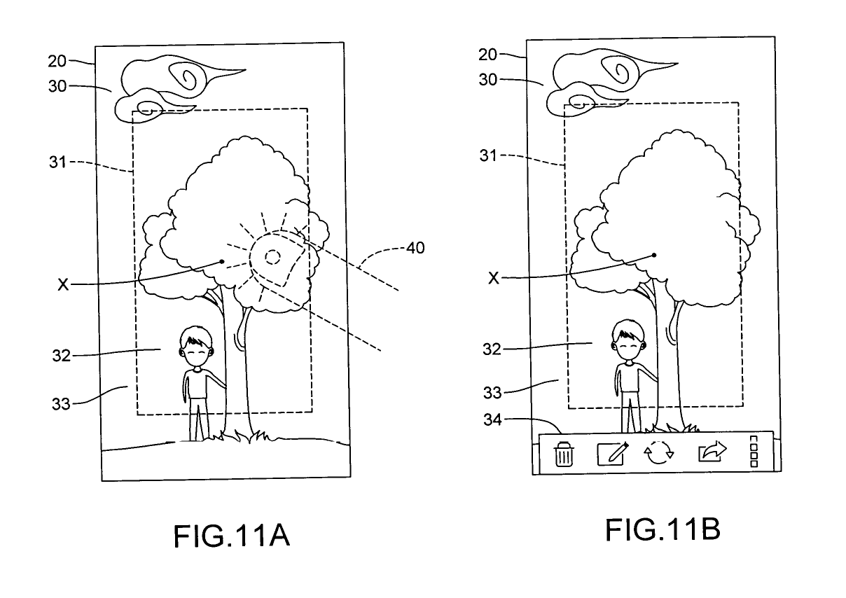

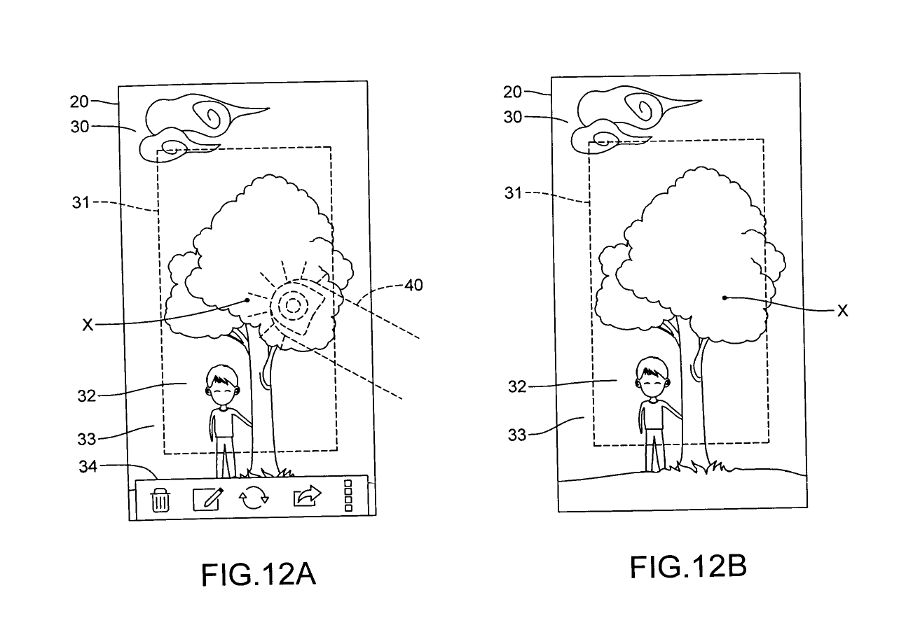

Please refer to FIGS. 11A and 11B, when a tapping motion is made by the user, a controls 34 is shown. Furthermore, a next tapping motion or a double-tapping motion is made, the controls are hidden, please see FIGS. 12A and 12B.

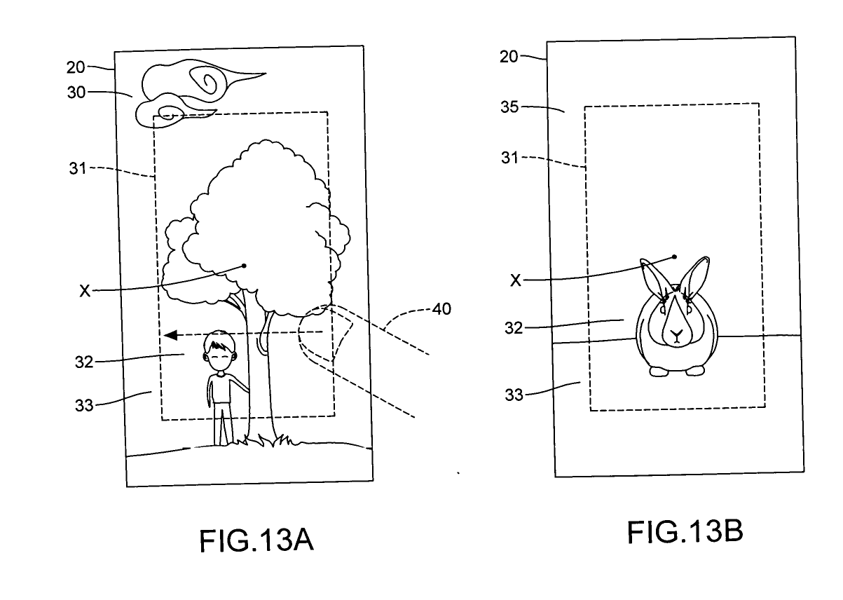

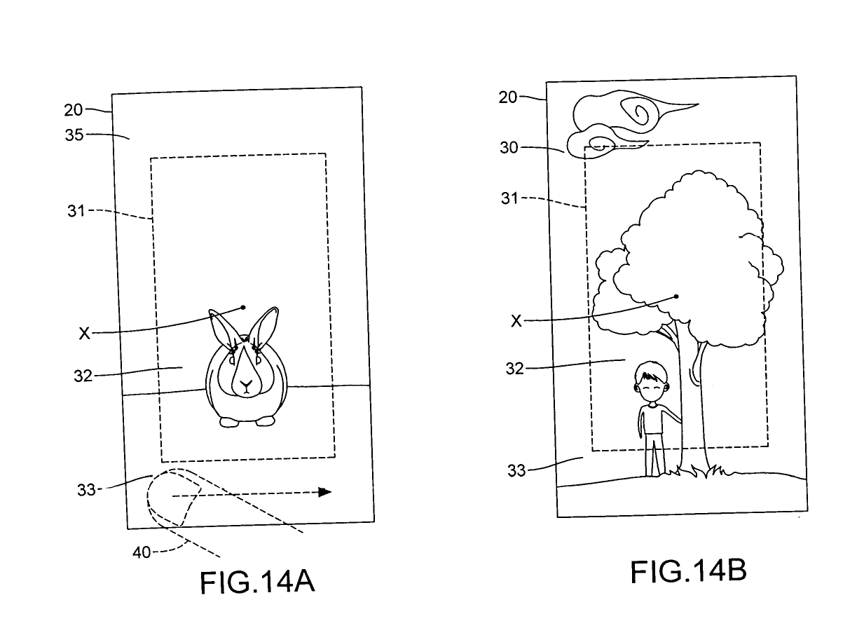

Sweeping the picture 30 from left to right or from right to left across the picture borders changes to the next or previous picture 30 on the screen 20, regardless of the picture 30 is zoomed in or not, please refer to FIGS. 13A and 13B. When the picture 30 is not zoomed in, a sliding motion on the outer area 33 from left to right or from right to left moves the next or previous picture 30 on the screen 20, please refer to FIGS. 14A and 14B.

Excepting for the picture 30, any item displayed on the screen 20 may be zoomed, such as a digital image, a document, etc. Furthermore, the above-mentioned motion can also be made by a mechanical tool, such as a touch pen, or anything similar.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. A computing device-implemented method, comprising:
detecting, by a processor of the computing device, that a sliding motion is being made on a touch screen of the computing device;
detecting, by the processor and in response to detecting the sliding motion, an initial location and an initial orientation of the sliding motion;
identifying, by the processor and in response to detecting the sliding motion and the initial location and the initial orientation of the sliding motion, an item, being displayed by the touch screen, wherein a center area and an outer area of the item are defined; and
zooming in or zooming out, by the processor, on the item displayed on the touch screen based on the relationship of the initial location and the initial orientation of the sliding motion, and the center area and the outer area of the item and in response to the processor detecting that the sliding motion is being made on the touch screen.

2. The method of claim 1, wherein the outer area is 15% of a width and a height of the item counting from edges of all sides of the item and the center area covers the remaining area of the item, totaling 70% of the width and height of the item.

3. The method of claim 2, wherein when the initial location is located at the center area and the initial orientation of the sliding motion is towards to a focal point of the item, the zooming out from the same initial location is performed by the processor as long as the sliding action continues regardless of a later direction of the same sliding action.

4. The method of claim 2, wherein when the initial location is located at the center area and the initial orientation of the sliding motion is outwards from a focal point of the item, the zooming in to the same initial location is performed by the processor as long as the sliding motion continues regardless of a later direction of the same sliding motion.

5. The method of claim 2, wherein when the initial location is located at a focal point of the item, the zooming in to the same initial location is performed by the processor.

6. The method of claim 2, wherein when the initial location is located at a boundary of the center area, the zooming out from or in to the same initial location is performed by the processor depending on the initial orientation of the sliding motion.

7. The method of claim 2, wherein when the item is zoomed in, and the initial location is located at the outer area, the item is moved by the processor along the orientation of the sliding motion.

8. The method of claim 1, further comprising: storing, in a memory of the computing device, a plurality of parameters, the parameters being associated with how the zooming in or zooming out is performed by the processor.

9. The method of claim 8, wherein the parameters include a minimum size parameter that indicates a percentage of an original size to which the item can be zoomed out, where the original size corresponds to a displayed size of the item prior to detecting the sliding motion, and where zooming in or zooming out on the item includes: zooming out on the item to a size corresponding or exceeding the minimize size parameter.

10. The method of claim 8, wherein the plurality of parameters include a maximum size parameter that indicates a percentage of an original size to which the item can be zoomed in, where the original size corresponds to a displayed size of the item prior to detecting the circular motion, and where zooming in or zooming out on the item includes: zooming in on the item to a size at or below the maximum size parameter.

11. A computing device, comprising:
a touch-sensitive screen;
a memory to store a plurality of instructions; and
a processor to execute instructions in the memory to:
detect a sliding motion is being made on the touch-sensitive screen;
detect, in response to detecting the sliding motion, an initial location and an initial orientation of the sliding motion;
identify, in response to detecting the sliding motion and the initial location and the initial orientation of the sliding motion, an item, being displayed by the touch screen, wherein a center area and an outer area of the item are defined; and
zoom in or zoom out on the item displayed on the touch-sensitive screen, in response to the processor detecting that the sliding motion is being made on the touch-sensitive screen, based on the relationship of the initial location and the orientation of the sliding motion, and the center area and the outer area of the item.

12. The device of claim 11, wherein the outer area is 15% of a width and a height of the item counting from edges of all sides of the item and the center area covers the remaining area of the item, totaling 70% of the width and height of the item.

13. The device of claim 12, wherein when the initial location is located at the center area and the initial orientation of the sliding motion is towards to a focal point of the item, the zooming out from the same initial location is performed by the processor as long as the sliding motion continues regardless of a later direction of the same sliding motion.

14. The device of claim 12, wherein when the initial location is located at the center area and the initial orientation of the sliding motion is outwards from a focal point of the item, the zooming in to the same initial location is performed by the processor as long as the sliding motion continues regardless of a later direction of the same sliding motion.

15. The device of claim 12, wherein when the initial location is located at a focal point of the item, the zooming in to the same initial location is performed by the processor.

16. The device of claim 12, wherein when the initial location is located at the boundary of the center area, zooming out from or in to the same initial location is performed by the processor depending on the initial orientation of the sliding motion.

17. The device of claim 12, wherein when the item is zoomed in, and the initial location is located at the outer area, the item is moved by the processor along the orientation of the sliding motion.

18. The device of claim 11, wherein the memory further comprises a plurality of parameters, the parameters being associated with how the zooming in or zooming out is performed by the processor.

19. The device of claim 18, wherein the parameters include a minimum size parameter that indicates a percentage of an original size to which the item can be zoomed out, where the original size corresponds to a displayed size of the item prior to detecting the sliding motion, and where zooming in or zooming out on the item includes: zooming out on the item to a size corresponding or exceeding the minimize size parameter.

20. The device of claim 18, wherein the plurality of parameters include a maximum size parameter that indicates a percentage of an original size to which the item can be zoomed in, where the original size corresponds to a displayed size of the item prior to detecting the sliding motion, and where zooming in or zooming out on the item includes: zooming in on the item to a size at or below the maximum size parameter.
